(19) United States
(12) Patent Application Publication
(10) Pub. No.: US 2006/0062226 A1
(43) Pub. Date: Mar. 23, 2006

(54) Switched fabric rear transition module and method

(76) Inventors: Jeffrey M. Harris, Chandler, AZ (US); Douglas L. Sandy, Chandler, AZ (US); Robert C. Tufford, Chandler, AZ (US)

Correspondence Address: MOTOROLA, INC., LAW DEPARTMENT, 1303 E. ALGONQUIN ROAD, SCHAUMBURG, IL, 60196, US

(21) Appl. No.: 10/947,968

(22) Filed: Sep. 23, 2004

(51) Int. Cl. H04L 12/56; H04J 3/22

(52) U.S. Cl. 370/401; 370/465; 370/351

(57) ABSTRACT

A multi-service platform system, includes a backplane (104), a switched fabric (106) on the backplane, and at least one of a VMEbus network and a PCI network coincident with the switched fabric on the backplane. A payload module (102) has one of a 3U form factor, a 6U form factor and a 9U form factor, where the payload module is communicatively coupled with the backplane using the switched fabric and at least one of the VMEbus network and the PCI network. At least one multi-gigabit connector (118) is coupled to a rear edge (119) of the payload module, where the at least one multi-gigabit connector is coupled to communicatively interface the payload module to the backplane, and where the switched fabric and at least one of the VMEbus network and the PCI network are communicatively coupled with the payload module through the at least one multi-gigabit connector. A switched fabric link coupling payload module and a rear transition module (175) operates using a switched fabric protocol. The rear transition module is coupled to a rear portion (190) of the backplane, where the rear transition module is substantially coplanar with the payload module, wherein the switched fabric link extends from the payload module through the backplane to the rear transition module.

### BACKGROUND OF THE INVENTION

Expansion cards can be added to computer systems to lend additional functionality or augment capabilities. Current expansion cards interface and communicate with computer systems using primarily a multi-drop parallel bus network architecture, such as Peripheral Component Interconnect (PCI) or VERSAmodule Eurocard (VMEbus). A multi-drop parallel bus architecture has the disadvantage that it can only be used to support one instantaneous communication between modules in a computer system or network. However, some applications have requirements for simultaneous high bandwidth transfers between modules that cannot be handled by the multi-drop parallel bus architecture.

In the prior art, rear transition modules in embedded computer systems could only support low-speed communication from/to the embedded chassis. This has the disadvantage of limiting communication speed between multiple chassis.

In the prior art, 6U form factor cards are common. The 3U form factor offers an advantage for applications where physical space is at a premium. The 9U form factor offers an advantage of placing more computing features on a given card. Prior art 3U and 9U form factor expansion cards interface with a backplane using parallel multi-drop networks. This has the disadvantage of being slow and cumbersome for network expansion.

Accordingly, there is a significant need for an apparatus and method that overcomes the deficiencies of the prior art outlined above.

### BRIEF DESCRIPTION OF THE DRAWINGS

Referring to the drawing:

FIG. 1 depicts a multi-service platform system according to one embodiment of the invention; and

FIG. 2 depicts a multi-service platform system according to another embodiment of the invention.

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENTS

In the following detailed description of exemplary embodiments of the invention, reference is made to the accompanying drawings, which illustrate specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

For clarity of explanation, the embodiments of the present invention are presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

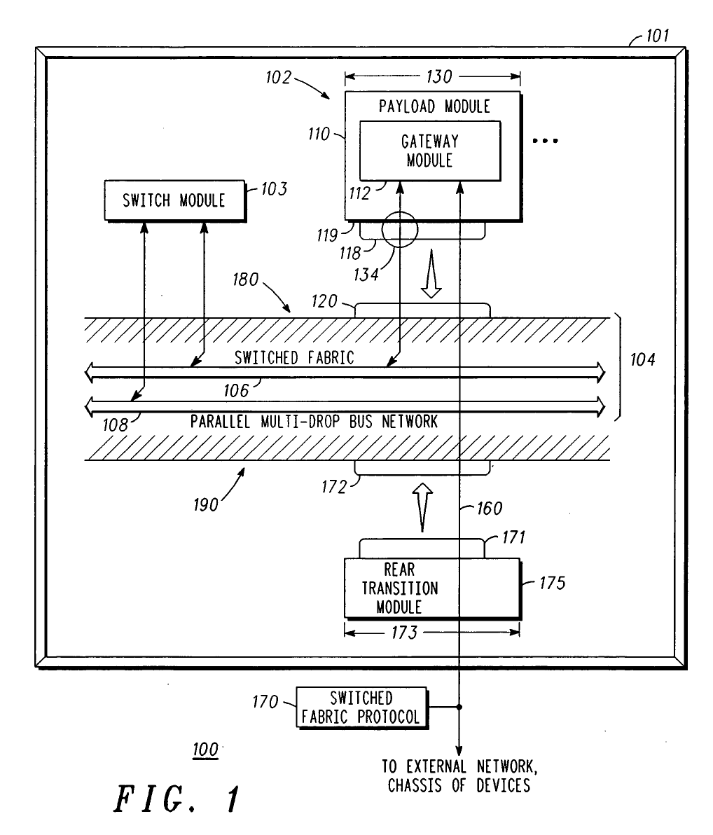

FIG. 1 depicts a multi-service platform system 100 according to one embodiment of the invention. Multi-service platform system 100 can include computer chassis 101, with software and any number of slots for inserting modules, which can be, for example and without limitation, a payload module 102, a switch module 103, a rear transition module 175 and the like. Payload module 102 can add functionality to multi-service platform system 100 through the addition of processors, memory, storage devices, device interfaces, network interfaces, and the like. In an embodiment, multi-service platform system 100 can be an embedded, distributed processing computer system, where computer chassis 101 is an embedded computer chassis.

In an embodiment, multi-service platform system 100 can be controlled by a platform controller (not shown for clarity), which can include a processor for processing algorithms stored in memory. Memory comprises control algorithms, and can include, but is not limited to, random access memory (RAM), read only memory (ROM), flash memory, electrically erasable programmable ROM (EEPROM), and the like. Memory can contain stored instructions, tables, data, and the like, to be utilized by processor. Platform controller can be contained in one, or distributed among two or more payload modules with communication among the various modules of multi-service platform system 100.

Multi-service platform system 100 can include backplane 104 coupled for receiving payload module 102 and switch module 103. Backplane 104 can include hardware and software necessary to implement a coincident parallel multi-drop bus network 108 and a switched fabric 106. Backplane 104 can include switched fabric 106 and a parallel multi-drop bus network 108. In an embodiment, both switched fabric 106 and parallel multi-drop bus network 108 run concurrently on backplane 104.

In an embodiment, backplane 104 can include front portion 180 coupled for receiving any number of payload modules 102 or switch modules 103. Backplane 104 can also include rear portion 190 coupled for receiving any number of rear transition modules 175. In an embodiment, rear transition module 175 can be used as an interface for signals entering and exiting computer chassis 101.

In an embodiment, parallel multi-drop bus network 108 can be a VMEbus network. VMEbus network is defined in the ANSI/VITA 1-1994 and ANSI/VITA 1.1-1997 standards, promulgated by the VMEbus International Trade Association (VITA), P.O. Box 19658, Fountain Hills, Ariz., 85269 (where ANSI stands for American National Standards Institute). In an embodiment of the invention, VMEbus network can include VMEbus based protocols such as Single Cycle Transfer protocol (SCT), Block Transfer protocol (BLT), Multiplexed Block Transfer protocol (MBLT), Two Edge VMEbus protocol (2 eVME) and Two Edge Source Synchronous Transfer protocol (2eSST). VMEbus network 108 is not limited to the use of these VMEbus based protocols and other VMEbus based protocols are within the scope of the invention.

In another embodiment, parallel multi-drop bus network 108 can be a Peripheral Component Interconnect (PCI) network. PCI network can include standard PCI or Peripheral Component Interconnect-X (PCI-X) based protocols. Examples of variants of PCI-X protocols, without limitation, include 133 MHz 64-bit PCI-X, 100 MHz 64-bit PCI-X down to 66 MHz 32-bit PCI-X, and the like. Examples of PCI based protocols (a subset of PCI-X based protocols), can include 66 MHz 64-bit PCI down to 33 MHz 32-bit PCI, and the like.

Switched fabric 106 can use switch module 103, particularly at least one central switching resource on switch module, as a hub. Switch module 103 can be coupled to any number of payload modules 102. Switched fabric 106 can be based on a point-to-point, switched input/output (I/O) fabric, whereby cascaded switch devices interconnect end node devices. Although FIG. 1 depicts switched fabric 106 as a bus for diagrammatic ease, switched fabric 106 may in fact be a star topology, mesh topology, and the like as known in the art for communicatively coupling modules. Switched fabric 106 can include both module-to-module (for example computer systems that support I/O module add-in slots) and chassis-to-chassis environments (for example interconnecting computers, external storage systems, external Local Area Network (LAN) and Wide Area Network (WAN) access devices in a data-center environment). Switched fabric 106 can be implemented by using one or more of a plurality of switched fabric protocols 170, for example and without limitation, InfiniBand™, Serial RapidIO™, FibreChannel™, Ethernet™, PCI Express™, Hypertransport™, and the like. Switched fabric 106 is not limited to the use of these switched fabric protocols 170 and the use of any switched fabric protocol 170 is within the scope of the invention.

In an embodiment of the invention, parallel multi-drop bus network 108 and switched fabric 106 operate concurrently within multi-service platform system 100. In an example of an embodiment, parallel multi-drop bus network 108 can operate as a control plane by synchronizing and organizing activities in multi-service platform system 100. Switched fabric 106 can operate as a data plane by transferring data between individual payload modules 102. In this embodiment, data is transferred faster through the higher bandwidth switched fabric 106, while the parallel multi-drop bus network 108 controls and manages the overall system. This has the effect of increasing the speed of multi-service platform system 100 since data transfers that are in excess of parallel multi-drop bus network 108 bandwidth can take place using switched fabric 106. In an embodiment, payload module 102 is communicatively coupled with backplane 104 using switched fabric 106 and at least one of VMEbus network or PCI network (parallel multi-drop bus network 108).

Multi-service platform system 100 can include any number of payload modules 102, switch modules 103 and rear transition modules 175 coupled to backplane 104. Backplane 104 can include hardware and software necessary to implement a coincident parallel multi-drop bus network 108 and a switched fabric 106.

In an embodiment, payload module 102 can comprise a board 110, for example a printed wire board (PWB), and the like. In an embodiment, payload module 102 can have a form factor 130, which can refer to physical dimensions, electrical connections, and the like, of payload module 102. In an embodiment, payload module 102 can have one of a 3U form factor, 6U form factor or a 9U form factor.

As is known in the art, “U” and multiples of “U” can refer to the width of a module or expansion card. In an embodiment, “U” can measure approximately 1.75 inches. Payload module 102 can have its own specific set of electrical connections to interface with backplane 104 of computer chassis 101. As an example of an embodiment, multi-service platform system 100 can include computer chassis 101 and one or more payload modules 102, each having one of a 3U form factor, 6U form factor or a 9U form factor. In an embodiment, such payload modules 102 can conform to the VITA 46 standard as set forth by VMEbus International Trade Association (VITA), P.O. Box 19658, Fountain Hills, Ariz., 85269.

In an embodiment, switch module 103 can comprise a board, for example a PWB, and the like. Coupled to the board can be one or more central switching resources that can for example, function as a hub for switched fabric 106. In an embodiment, switch module 103 can include any combination of processor, memory, storage, communication devices and the like. Switch module 103 can add any type of computing, storage, communication features, and the like to multi-service platform system 100. Multi-service platform system can include any number of switch modules 103 coupled to operate any number of switched fabrics. For example, in an embodiment, multi-service platform system can include two switch modules, where switched fabric 106 comprises a first and second switch fabric. In this embodiment, each switch module is coupled to operate or act as a hub for each of the first and second switched fabric.

In an embodiment, rear transition module 175 can be used to interface computer chassis 101 to external networks, chassis, devices, and the like. For example, rear transition module 175 can be used to interface computer chassis 101 to other chassis, other networks such as Ethernet, the Internet, and the like. Also, rear transition module 175 can be used to interface multi-service platform system 100 with devices such as storage drives, memory, processors, and the like. Rear transition module 175 can also have a form factor 173, which can include any of the 3U, 6U or 9U form factors described above.

In an embodiment, each rear transition module 175 can have a corresponding payload module or corresponding switch module. The embodiment, depicted in FIG. 1 illustrates rear transition module 175 and a corresponding payload module 102. This is not limiting of the invention, as switch module 103 can have a corresponding rear transition module and be within the scope of the invention. In an embodiment, within computer chassis 101, rear transition module 175 is substantially coplanar to its corresponding payload module or corresponding switch module. This can mean that rear transition module 175 coupled to rear portion 190 of backplane 104 is substantially in the same plane as its corresponding payload module or corresponding switch module coupled to the front portion 180 of backplane 104.

In an embodiment, rear transition module 175 can be coupled directly to switched fabric 106 and/or parallel multi-drop bus network 108. Also, rear transition module 175 can be coupled to corresponding payload module 102 through backplane 104. Rear transition module 175 can be coupled to any combination of parallel multi-drop bus network 108, switched fabric 106 and payload module 102 and be within the scope of the invention.

In an embodiment, backplane 104 and payload module 102 can have a set of interlocking, modular connectors designed to interlock with each other when payload module 102 is placed in a slot of multi-service platform system 100. In the embodiment shown, payload module 102 has at least one multi-gigabit connector 118 coupled to rear edge 119. In an embodiment, at least one multi-gigabit connector 118 can include printed circuit board (PCB) wafers (as opposed to metal pins), where wafers are held together in a plastic housing and can be coupled to the payload module 102 using press to fit contacts. For example, at least one multi-gigabit connector 118 can use PCB based pinless interconnect that uses printed circuit wafers instead of traditional pin and socket contacts.

In an embodiment, at least one multi-gigabit connector 118 can use at least one of single ended or differential pair 134 signal configuration in the same connector. Multi-gigabit connector 118 can transfer data in excess of three (3) gigabits per second per each differential pair 134. In an embodiment, differential pair 134 can be a bonded differential pair. At least one multi-gigabit connector 118 is coupled to communicatively interface payload module 102 with backplane 104, where switched fabric 106 and at least one of VMEbus network or PCI network are communicatively coupled to payload module 102 through at least one multi-gigabit connector 118.

In an embodiment, at least one multi-gigabit connector 118 is coupled to interface with at least one corresponding multi-gigabit connector 120 on backplane 104. At least one corresponding multi-gigabit connector 120 can be a female receptacle with metal beam spring leaf contacts which engage with the PCB wafers of multi-gigabit connector 118 when coupled together.

In an embodiment, at least one multi-gigabit connector 118 spans substantially the entire portion of the rear edge 119 of payload module 102. Rear edge 119 can include any number of multi-gigabit connectors 118 and be within the scope of the invention. In an embodiment, all communication between payload module 102 and backplane 104 occur exclusively through at least one multi-gigabit connector 118. In this embodiment, rear edge 119 of payload module 102 excludes a legacy connector, which can include traditional pin and socket connectors designed for low-speed data transfer. In other words, all data transfer and communication, whether to/from switched fabric 106 and at least one of VMEbus network or PCI network (parallel multi-drop bus network 108) occur through at least one multi-gigabit connector 118.

In an example of an embodiment of the invention, at least one multi-gigabit connector 118 and corresponding at least one multi-gigabit connector 120 can be a Tyco MultiGig RT connector manufactured by the AMP division of Tyco Electronics, Harrisburg, Pa. The invention is not limited to the use of the Tyco MultiGig RT connector, and any connector capable of throughput per differential pair of at least three gigabits per second is encompassed within the invention.

In an embodiment, rear transition module 175 can include at least one rear transition module (RTM) multi-gigabit connector 171 coupled to interface with corresponding at least one RTM multi-gigabit connector 172 on rear portion 190 of backplane 104. Both RTM multi-gigabit connector 171 and corresponding RTM multi-gigabit connector 172 can be the same type and have the same features as at least one multi-gigabit connector 118 and corresponding multi-gigabit connector 120 described above.

In an embodiment, rear transition module 175 can also exclude a legacy connector, which can include traditional pin and socket connectors designed for low-speed data transfer. In other words, all data transfer and communication with or through rear transition module 175, whether to/from switched fabric 106 and at least one of VMEbus network or PCI network (parallel multi-drop bus network 108) occurs through at least one RTM multi-gigabit connector 171.

In an embodiment, all of the above multi-gigabit connectors and corresponding multi-gigabit connectors can be electrical, optical, radio frequency, biological, and the like, type connectors designed for use with any of the plurality of switched fabric protocols 170.

When rear transition module 175 is placed in a slot and coupled to rear portion 190 of backplane 104, the functionality of rear transition module 175 can be added to multi-service platform system 100. This functionality can be added via directly connecting to parallel multi-drop bus network 108 or by coupling to corresponding payload module 102. For example, I/O elements, and the like, on rear transition module 175 can be accessible by other payload modules in multi-service platform system 100. These I/O elements can access external networks, chassis, devices, and the like, for example, external storage devices, external networks such as the Internet, other computer chassis, and the like.

In another embodiment, when rear transition module 175 is placed in a slot and coupled to rear portion 190 of backplane 104, the functionality of rear transition module 175 can be added to multi-service platform system 100. This functionality can be added via directly connecting to switched fabric 106 or by coupling to corresponding payload module 102. For example, I/O elements, and the like, on rear transition module 175 can be accessible by other payload modules in multi-service platform system 100.

In an embodiment, switched fabric link 160 can extend switched fabric 106 from backplane 104, to networks, chassis, devices, and the like, external to computer chassis 101. In the embodiment, shown, switched fabric link 160 extends from payload module 102 through backplane 104 to rear transition module 175. Switched fabric link 160 then exits computer chassis 101 through rear transition module 175. In an embodiment, switched fabric link 160 can communicatively couple payload module 102 to rear transition module 175. Switched fabric link 160 can extend through at least one multi-gigabit connector 118 and at least one RTM multi-gigabit connector 171. Switched fabric link 160 can include any type of medium to communicate data signals using switched fabric protocol 170, for example, copper, optical, and the like.

In an embodiment, switched fabric link 160 can originate at gateway module 112 on payload module 102. Gateway module 112 can be any combination of hardware, software, and the like that processes or creates data signals to or from switched fabric 106. In an embodiment, gateway module 112 is also coupled to switched fabric 106. Gateway module 112 can function to process incoming and outgoing data signals from computer chassis 101 on switched fabric link 160 using switched fabric protocol 170. In effect, gateway module 112 and switched fabric link 160 extend switched fabric 106 from a single computer chassis 101 and backplane 104, to any number of networks, chassis, devices, and the like, that are external to computer chassis 01 and backplane 104. In an embodiment, switched fabric 106 and switched fabric link 160 operate using the same switched fabric protocol. In another embodiment, switched fabric 106 communicates with at least one external network, external chassis, external device, and the like through switched fabric link 160 using a different switch fabric protocol than used on backplane 104.

In the embodiment shown, only one switched fabric link 160 is shown. This is not limiting of the invention. Switched fabric link 160 can be divided into any number of switched fabric links exiting multi-service platform system 100. For example, although not shown in FIG. 1, bridging circuitry can be provided on rear transition module 175 to bridge a copper switched fabric link 160, for example, to any number of optical switched fabric links exiting multi-service platform system 100. In another embodiment, although not shown in FIG. 1, switching circuitry can be provided on rear transition module 175 for a plurality of switched fabric links 160 exiting multi-service platform system 100.

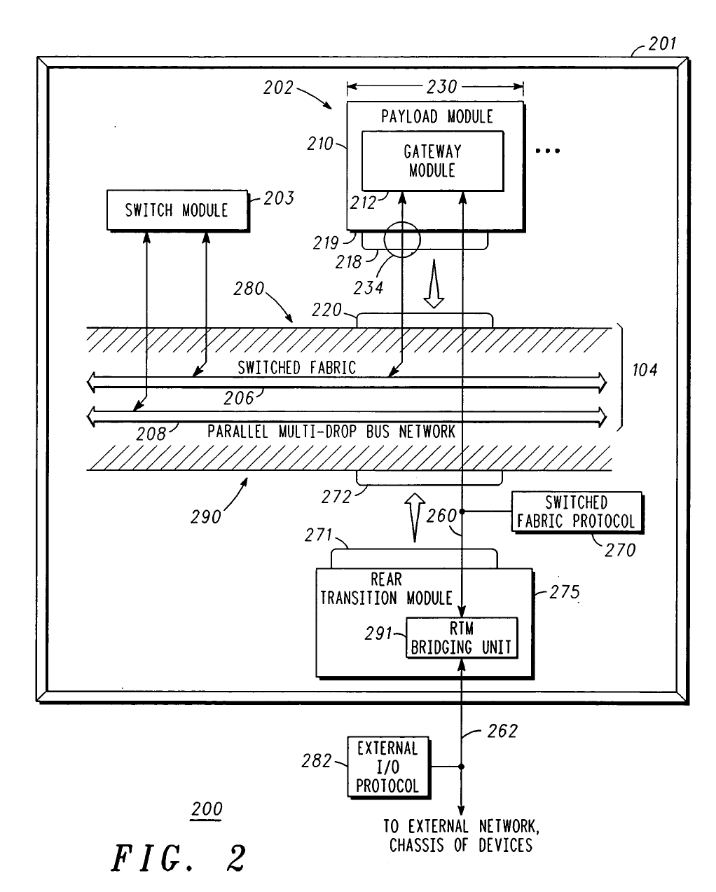

FIG. 2 depicts a multi-service platform system according to another embodiment of the invention. In the embodiment depicted in FIG. 2, like numbered elements represent elements discussed with reference to FIG. 1. For example, payload module 202 depicted in FIG. 2 is analogous to payload module 102 depicted in FIG. 1.

In an embodiment, switched fabric link 260 can extend switched fabric 206 from payload module 202 to rear transition module 275 through backplane 204. In an embodiment, switched fabric link 260 can communicatively couple payload module 202 to rear transition module 275. Switched fabric link 260 can include any type of medium to communicate data signals using switched fabric protocol 270, for example, copper, optical, and the like.

In an embodiment, switched fabric link 260 can originate at gateway module 212 on payload module 202. Gateway module 212 can be any combination of hardware, software, and the like that processes or creates data signals to or from switched fabric 206. In an embodiment, gateway module 212 is also coupled to switched fabric 206. Gateway module 112 can function to process incoming and outgoing data signals from computer chassis 201 on switched fabric link 260 using switched fabric protocol 270.

Switched fabric link 260 can terminate at a rear transition module (RTM) bridging unit 291 on rear transition module 275. RTM bridging unit 291 can function to bridge data communicated using switched fabric protocol 270 to an external input/output (I/O) protocol 282. Data can be bridged from switched fabric link 260 using switched fabric protocol 270 to an external link 262 using external I/O protocol 282. External link 262 can extend outside of computer chassis 203 from rear transition module 275 to one or more external networks, devices, and the like.

In an embodiment, external I/O protocol 282 transfers data at a slower rate than switched fabric protocol 270. In an embodiment, switched fabric link 260 using switched fabric protocol 270 can transfer data at a rate of at least one gigabit per second. In an embodiment, external link 262 transfers data using external I/O protocol 282 at least an order of magnitude slower than switched fabric protocol 270. In an embodiment, external I/O protocol 282 can include any number of legacy protocols, for example and without limitation, Small Computer System Interface (SCSI), IDE, AT Attachment (ATA), RS232, PS/2, and the like.

In an embodiment, external link 262 couples payload module 202 via rear transition module 275 to at least one external network, device, and the like. External network, device, and the like, can be networks or devices that operate using at least one external I/O protocol 282, for example, storage devices, keyboards, printers, and the like. Switched fabric link 260, RTM bridging unit 291 and external link 262 are configured such that switched fabric 206 is coupled to communicate with at least one external network or device using switched fabric protocol 270 and external I/O protocol 282.

In the embodiment shown, only one external link 262 is shown. This is not limiting of the invention. External link 262 can be divided into any number of external links exiting multi-service platform system 200. In an embodiment, external link 262 can be comprised of any number of copper links, optical links, and the like.

While we have shown and described specific embodiments of the present invention, further modifications and improvements will occur to those skilled in the art. It is therefore, to be understood that appended claims are intended to cover all such modifications and changes as fall within the true spirit and scope of the invention.

1. A multi-service platform system having a backplane integrated with a computer chassis, the multi-service platform system comprising:
a switched fabric on the backplane;
at least one of a VMEbus network and a PCI network coincident with the switched fabric on the backplane;
a payload module having one of a 3U form factor, a 6U form factor and a 9U form factor, wherein the payload module is coupled to a front portion of the backplane, and wherein the payload module is communicatively coupled with the backplane using the switched fabric and at least one of the VMEbus network and the PCI network;
at least one multi-gigabit connector coupled to a rear edge of the payload module, wherein the at least one multi-gigabit connector is coupled to communicatively interface the payload module to the backplane, and wherein the switched fabric and at least one of the VMEbus network and the PCI network are communicatively coupled with the payload module through the at least one multi-gigabit connector;
a switched fabric link, wherein the switched fabric link operates using a switched fabric protocol; and
a rear transition module coupled to a rear portion of the backplane, wherein the rear transition module is substantially coplanar with the payload module, wherein the switched fabric link extends from the payload module through the backplane to the rear transition module.

2. The multi-service platform system of claim 1, wherein the switched fabric link exits the computer chassis through the rear transition module.

3. The multi-service platform system of claim 1, wherein the switched fabric link couples the computer chassis and the backplane to at least one of an external network, external chassis and external device through the rear transition module.

4. The multi-service platform system of claim 1, wherein the switched fabric communicates within the computer chassis on the backplane using the switched fabric protocol, and wherein the switched fabric communicates with at least one of an external network, external chassis and external device through the switched fabric link using the switched fabric protocol.

5. The multi-service platform system of claim 1, further comprising an RTM bridging unit on the rear transition module, wherein the switched fabric link terminates at the RTM bridging unit, and wherein the RTM bridging unit bridges the switched fabric protocol to an external link operating an external I/O protocol, wherein the external I/O protocol transfers data at least an order of magnitude slower than the switched fabric protocol, and wherein the external link extends outside of the computer chassis from the rear transition module.

6. The multi-service platform system of claim 5, wherein the switched fabric link transfers data at least one gigabit per second.

7. The multi-service platform system of claim 5, wherein the external link couples the payload module to at least one of an external network and an external device that operates using the external I/O protocol.

8. The multi-service platform system of claim 5, wherein the switched fabric is coupled to communicate with at least one of an external network and an external device via the RTM bridging unit using the external I/O protocol.

9. The multi-service platform system of claim 1, wherein communication between the payload module and the rear transition module occurs exclusively through the at least one multi-gigabit connector using the switched fabric link.

10. The multi-service platform system of claim 1, wherein at least one multi-gigabit connector spans substantially an entire portion of the rear edge of the payload module.

11. The multi-service platform system of claim 1, wherein the rear transition module comprises at least one RTM multi-gigabit connector coupled to interface the rear transition module to the backplane, and wherein the switched fabric link passes through the at least one RTM multi-gigabit connector.

12. A method, comprising:
providing a payload module coupled to a backplane, wherein the payload module has one of a 3U form factor, a 6U form factor and a 9U form factor;
providing at least one multi-gigabit connector directly coupled to a rear edge of the payload module, wherein the at least one multi-gigabit connector is coupled to communicatively interface the payload module to a backplane, wherein the backplane includes a switched fabric coincident with at least one of a VMEbus network and a PCI network, and wherein the switched fabric and at least one of the VMEbus network and the PCI network are communicatively coupled to the payload module through the at least one multi-gigabit connector; and
coupling the payload module on a front portion of the backplane to a rear transition module on a rear portion of the backplane via a switched fabric link, wherein the payload module and the rear transition module are substantially coplanar, wherein the switched fabric link extends through the backplane and at least one multi-gigabit connector, and wherein the switched fabric link operates using a switched fabric protocol.

13. The method of claim 12, further comprising extending the switched fabric external to the computer chassis and the backplane through a switched fabric link.

14. The method of claim 12, further comprising the switched fabric link exiting the computer chassis through the rear transition module.

15. The method of claim 12, further comprising the switched fabric link coupling the computer chassis and the backplane to at least one of an external network, external chassis and external device through the rear transition module.

16. The method of claim 12, further comprising:
the switched fabric communicating within the computer chassis on the backplane using the switched fabric protocol; and
the switched fabric communicating with at least one of an external network, external chassis and external device through the switched fabric link using the switched fabric protocol.

17. The method of claim 12, further comprising:
providing an RTM bridging unit on the rear transition module;
the switched fabric link terminating at the RTM bridging unit; and
the RTM bridging unit bridging the switched fabric protocol to an external link operating an external I/O protocol, wherein the external I/O protocol transfers data at least an order of magnitude slower than the switched fabric protocol, and wherein the external link extends outside of the computer chassis from the rear transition module.

18. The method of claim 17, wherein the switched fabric link transfers data at least one gigabit per second.

19. The method of claim 17, further comprising the external link coupling the payload module to at least one of an external network and an external device that operates using the external I/O protocol.

20. The method of claim 17, further comprising the switched fabric communicating with at least one of an external network and an external device via the RTM bridging unit using the external I/O protocol.

21. The method of claim 12, wherein communication between the payload module and the rear transition module occurs exclusively through the at least one multi-gigabit connector using the switched fabric link.

22. The method of claim 12, wherein the rear transition module comprises at least one RTM multi-gigabit connector coupled to interface the rear transition module to the backplane, and wherein the switched fabric link passes through the at least one RTM multi-gigabit connector.
